(19) United States
(12) Patent Application Publication
(10) Pub. No.: US 2007/0189885 A1
(43) Pub. Date: Aug. 16, 2007

(54) Assist device

(76) Inventors: Anthony J. Madormo, Willoughby, OH (US); Joseph S. Ptacek, Elyria, OH (US)

Correspondence Address: FORREST L. COLLINS LAW OFFICES, LLC, POST OFFICE BOX 41040, BRECKSVILLE, OH, 44141-0040, US

(21) Appl. No.: 11/353,908

(22) Filed: Feb. 14, 2006

(51) Int. Cl. B60P 1/04

(52) U.S. Cl. 414/467

(57) ABSTRACT

A device is provided to enable the easy removal of an item such as a wheelchair from the trunk of an automobile. The device is foldable and in its folded state is easily inserted into the trunk of an automobile.

### BACKGROUND OF THE INVENTION

1. Field of the Invention

The purpose of this invention is to aid in the placement and removal of items from a vehicle such as an automobile trunk.

2. Description of the Art Practices

Clement in U.S. Pat. No. 4,073,395 Feb. 14, 1978 An automobile trunk loading apparatus for loading wheelchairs, outboard motors and the like into the trunk of an automobile comprises a carrier frame on which the object to be located may be removably attached. The frame is connected at the end which is to extend into the interior of the trunk to a pair of chain-like track elements which are constructed of interconnected oppositely facing U-shaped channel links having engaging surfaces to limit the radius of curvature attainable by the chain in the direction extending upwardly from the trunk floor to a minimum radius and to limit the radius of curvature on the opposite side thereof to approximately a straight line. When an object is located in the trunk in a loaded position, the chain-like track elements lie flat on the floor of the trunk. To remove an object, the frame nearest the edge of the trunk is lifted up sufficiently to clear the trunk and then pulled horizontally out of the trunk. The chain-like track members roll up link by link and then straighten out to lift the opposite end of the frame upwardly out of the trunk. When the end of the frame to which the track elements are connected clears the edge of the trunk, the free end is lowered to the ground and the object carried by the frame may be removed from it. To load the trunk, the procedure is reversed.

Holliday in U.S. Pat. No. 5,129,559 issued Jul. 14, 1992 relates to a vehicle carrier bracket is formed from tubular steel and is releasably mounted to the rear trailer hitch of a vehicle for exterior transportation of bicycles, wheelchairs or the like. The carrier bracket provides for easy loading and unloading of the cargo and for safe and secure transportation. The bracket is easily assembled and mounted on the trailer hitch, and later can be quickly disassembled and removed therefrom when not in use.

Crawford in U.S. Pat. No. 5,096,361 issued Mar. 17, 1992 describes a device for loading and unloading a wheelchair into and out of a motor vehicle, consisting of a horizontal carriage track mounted transversely on the floor of the vehicle and extending the length of the compartment behind the front seat. A carriage block is slideably engaged with the carriage track and connected to a motor-actuated screw drive that causes it to slide along the track on command. An arm with a wheel-support track assembly conforming to the front wheels of a standard wheelchair is pivotally attached to the carriage block and can be extended to the outside of the vehicle to receive the folded wheelchair and move it in and out of the vehicle as the arm is retracted or extended as a result of the carriage block sliding across the track. The device is controlled by a single switch operable from the driver's seat.

Zimmer in U.S. Pat. No. 6,729,829 issued May 4, 2004 describes a wheelchair vehicle access system, wherein the wheelchair has a detachable seat connected to a carriage, and the vehicle has a folding ramp and a pathway for movement of the seat. The carriage locks onto the ramp and the seat is detached and moved on the vehicle pathway to a desired location, where it is secured in place. The ramp is then folded, which brings the carriage into the vehicle. To unload, the ramp is extended, the seat is released and rolled back onto the carriage.

United States Patent Application 20020076312 published Jun. 20, 2002 by Schatzler et al., describes a transport device for loading and unloading a trunk space of a motor vehicle is provided which includes at least one transport belt movably located on the bottom of the trunk space and at least two rollers for guiding the movable transport belt, wherein the at least one transport belt is located on the bottom of the trunk space and on a top surface of a vehicle part positioned adjacent to the bottom of the trunk space and capable of being pivoted into a horizontal position.

United States Patent Application 20030095856 to Ablabutyan et al., published May 22, 2003 describes a wheelchair lift for supporting a wheelchair bound passenger and for moving the passenger between ground level and an opening in a vehicle. The wheelchair lift includes a platform and pivotal mechanism engaging the platform as well as a bridge plate for assuming a horizontal orientation to enable the passenger to proceed through the vehicle opening and a vertical orientation to act as a roll stop as the platform proceeds between the ground and the vehicle opening. The bridge plate includes a non-linear channel configured within its side which engages a pivotal mechanism which includes an upper parallelogram structure and hydraulic apparatus to move the upper parallelogram structure to move the platform. Also included is a lower parallelogram structure which is in sliding engagement with the upper parallelogram structure during at least a portion of the motion when the platform is moved between the ground and the vehicle opening. The lower parallelogram also is provided with a saddle bolt for sliding engagement with the non-linear channel such that movement of the lower parallelogram acts to raise and lower the bridge plate upon movement of the platform.

To the extent that the foregoing references are relevant to the present invention, they are herein specifically incorporated by reference. To the extent that the foregoing patents and citations are relevant to the present invention they are herein incorporated by reference. The portion of the disclosure of this patent document contains material, which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### SUMMARY OF THE INVENTION

The present invention describes an assist device for use in a motor vehicle comprising:
An assist device for use in a motor vehicle comprising:
an assist device base;
an assist device first folding mechanism assist device base first folding mechanism movably connected with said assist device base;
an assist device base second folding mechanism movably connected with said assist device first folding mechanism; at least one assist device front roller mechanism connected with said assist device base;
an assist device first rail; and,
   said at least one assist device front roller mechanism slidable within said assist device first rail.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a perspective view of the use of the invention;

FIG. 2 is a perspective view of the invention in a folded condition;

FIG. 3 is a perspective view of the invention in an unfolded condition;

FIG. 4 is a plan view according to the invention;

FIG. 5 is a side view according to the invention;

FIG. 6 is a first sequential schematic view of the use of the invention;

FIG. 7 is a second sequential schematic view of the use of the invention;

FIG. 8 is a third sequential schematic view of the use of the invention;

FIG. 9 is a fourth sequential schematic view of the use of the invention;

FIG. 10 is a plan view of a second mode according to the invention; and,

FIG. 11 is a side view of a second mode according to the invention;

With more particular reference to the drawings the following is set forth.

### DETAILED DESCRIPTION OF THE INVENTION

A device is provided for the lifting of objects in and out of a vehicle. As the aging population continues to grow and has a greater relative mobility than the past generations it becomes important to provide devices to aid in the transport of wheelchairs.

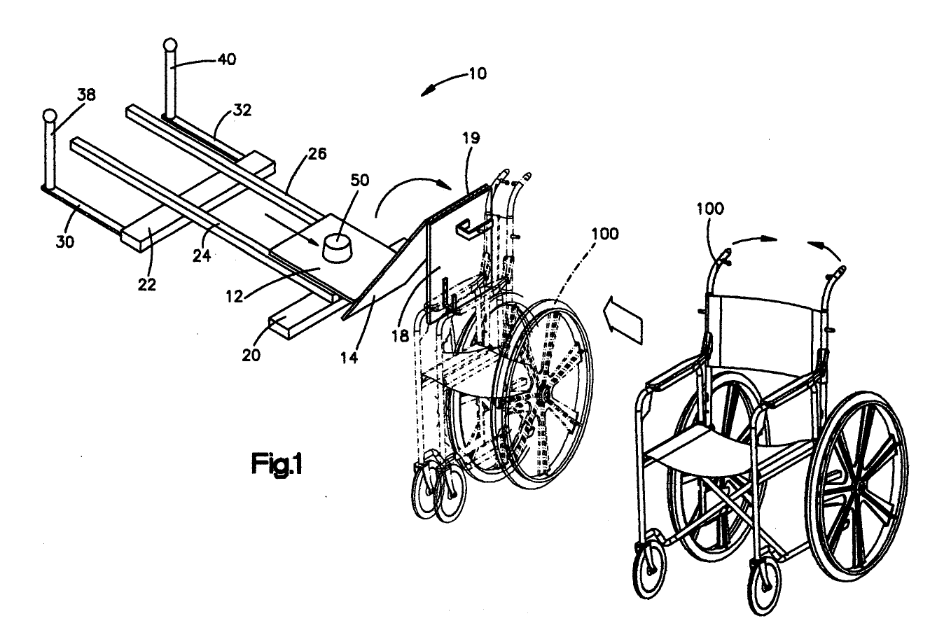

As best seen in a FIG. 1 is an assist device 10. The assist device 10 has an assist device base 12. The assist device base 12 is a generally rectangular flat board. The assist device base 12 is connected to an assist device base first folding mechanism 14.

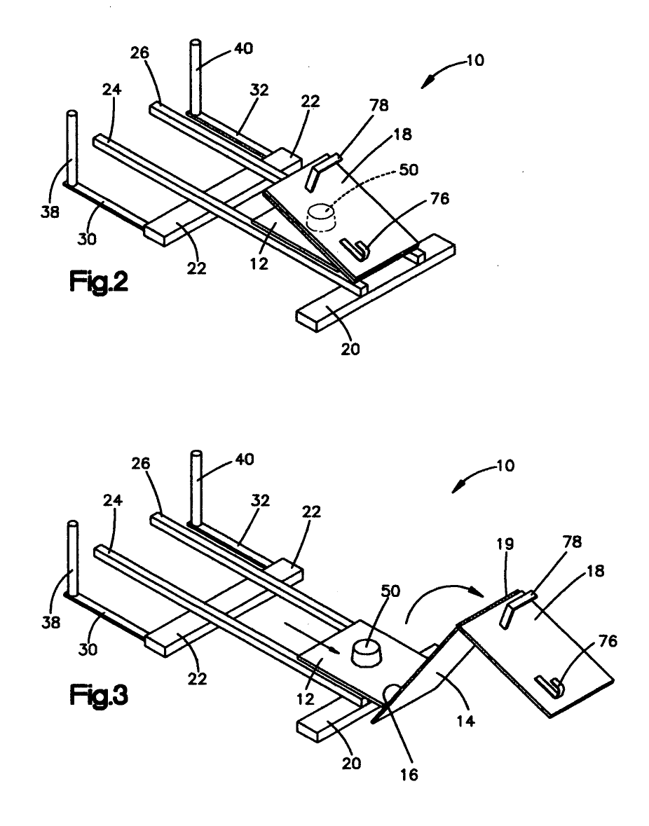

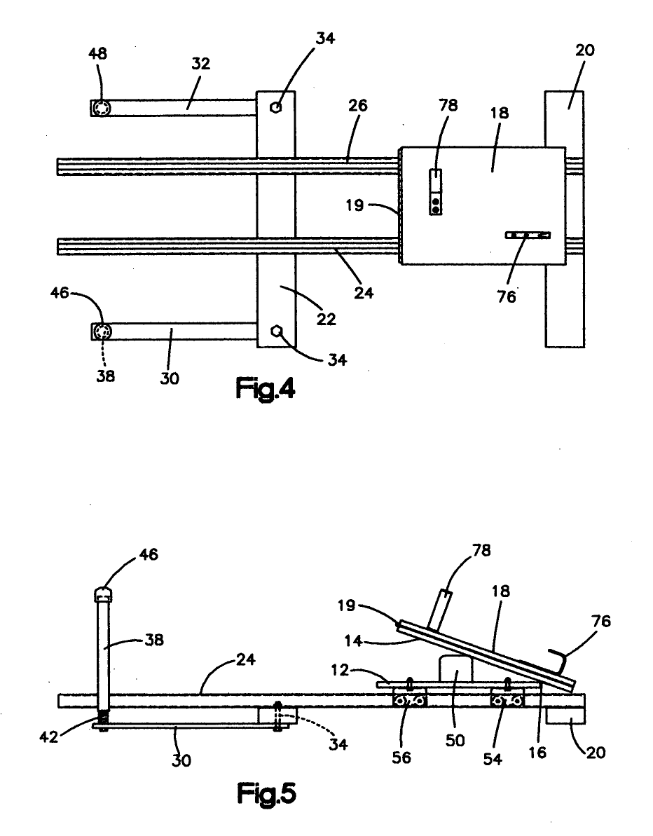

As best seen in FIG. 2 and FIG. 3 is the manner of connection of the assist device base 12 to the assist device base first folding mechanism 14. A first hinge 16 is connected to and extends along the width of the assist device base 12 at one end thereof.

The first hinge 16 is connected with and extends along the width of the assist device base first folding mechanism 14. The point of attachment of the first hinge 16 is spaced apart from the edge of the assist device base first folding mechanism 14 nearest the assist device base 12. Thus, when the first hinge 16 connects with one end of the assist device base first folding mechanism 14, the assist device base first folding mechanism 14 extends beyond the end of the assist device base 12.

The assist device base first folding mechanism 14 is also a generally rectangular flat board. The assist device base first folding mechanism 14 is slightly larger in its rectangular dimensions when compared to the assist device base 12. It suffices for the moment to state that in the assist device base 12 and the assist device base first folding mechanism 14 are in a partially rotatable relationship.

As best seen in FIG. 3 is the assist device base second folding mechanism 18 is connected to the assist device base first folding mechanism 14 by means of an assist device first hinge 16. The assist device first hinge 16 is essentially fully flexible to permit the need assist device base first folding mechanism 14 and the assist device base second folding mechanism 18 to be extended in the same plane. Similarly, the assist device base 12 and the assist device base first folding mechanism 14 are connected by an assist device second hinge 19.

The assist device base second folding mechanism 14 is a generally rectangular flat board. The connection of the assist device base second folding mechanism 14 with the assist device base second folding mechanism 18 is end to end. That is, one end of the assist device base first folding mechanism 14 is proximate to the assist device base second folding mechanism 18 and the other end of the assist device base second folding mechanism 14 is proximate to the assist device base 12.

The assist device base first folding mechanism 14 and the assist device base second folding mechanism 18 are in a partially rotatable relationship. The manner of movement of the assist device base first folding mechanism 14 and the assist device base second folding mechanism 18 is later discussed.

The dimensions of the assist device base second folding mechanism 18 are generally smaller than the of the assist device base first folding mechanism 14. The dimensions of the assist device base second folding mechanism 18 are approximately the same as of the assist device base 12.

The invention employs an assist device first crossbar 20. The invention employs an assist device second crossbar 22. The invention has an assist device first rail 24. The invention has an assist device second rail 26.

The assist device base 12 is connected with the assist device first rail 24. The assist device base 12 is also connected with an assist device second rail 26.

The assist device first crossbar 20 is connected with an assist device first rail 24. The assist device first crossbar 20 is also connected with the assist device second rail 26. The assist device first crossbar 20 provides stability to the assist device 10 by maintaining the assist device first rail 24 and assist device second rail 26 in a generally parallel relationship.

The assist device second crossbar 22 is connected with the assist device first rail 24. The assist device second crossbar 22 is also connected with the assist device second rail 26. The assist device second crossbar 22 functions to stabilize the assist device first rail 24 and the assist device second rail 26 in a generally parallel relationship. The assist device second crossbar 22 is generally of the same size as the assist device first crossbar 20.

Conveniently, the assist device first rail 24 terminates at one end of the assist device first crossbar 20. The assist device first rail 24 typically extends beyond the outer end of the assist device second crossbar 22.

The assist device second rail 26 terminates at one end of the assist device second crossbar 22. The assist device second rail 26 typically extends beyond the outer end of the assist device second crossbar 22.

An assist device rotatable first arm 30 is rotatably connected with the assist device first crossbar 20 at one end thereof. An assist device pivot mechanism 34 provides the ability for the assist device rotatable first arm 30 to rotate about its lengthwise axis. The assist device pivot mechanism 34 is maintained in its relationship with the assist device rotatable first arm 30 by the assist device first crossbar 20.

An assist device rotatable second arm 32 is rotatably connected with the assist device second crossbar 22 at the lengthwise opposite end of the assist device second crossbar 22 from the point of connection of the assist device rotatable first arm 30.

A second assist device pivot mechanism (not shown) similar in function and design to the assist device pivot mechanism 34 provides the ability for the assist device rotatable second arm 32 to rotate about its lengthwise axis. The second assist device pivot mechanism is maintained in its relationship with the assist device rotatable second arm 32 by the assist device first crossbar 20 in a manner similar to the to the assist device pivot mechanism 34. The assist device rotatable first arm 30 and the assist device rotatable second arm 32 are generally in the same plane and are in a parallel plane to the assist device first crossbar 20.

An assist device first trunk adapter 38 is rotatably connected with the assist device rotatable first arm 30. The assist device first trunk adapter 38 extends in generally perpendicular manner upward from the plane in which the rotatably connected assist device second crossbar 22 lies.

An assist device second trunk adapter 40 is rotatably connected with the assist device rotatable second arm 32. The assist device second trunk adapter 40 extends generally perpendicular manner upward from the plane in which the rotatably connected second crossbar 22 lies.

As best seen in FIG. 5, an assist device trunk adapter height adjuster 42 permits vertical adjustment of the assist device first trunk adapter 38. The assist device trunk adapter height adjuster 42 is conveniently a threaded surface of the assist device rotatable first arm 30 and a corresponding threaded surface of the assist device first trunk adapter 38. Similarly, an assist device trunk roof second adjustment tool (not shown) similar in function and design to the assist device trunk adapter height adjusters 42 permits vertical adjustment of the assist device second trunk adapter 40.

As seen in FIG. 5, an assist device first trunk adapter cap 46 is located at one end of the assist device first trunk adapter 38 opposite from the point of connection of the assist device first trunk adapter 38 to the assist device rotatable first arm 30. The assist device first trunk adapter cap 46 functions to engage the trunk roof of a vehicle in which the 10 is positioned to prevent unwanted movement of the assist device 10.

The assist device first trunk adapter cap 46 also protects the trunk roof of a vehicle in which the assist device 10 is positioned from damage. The assist device first trunk adapter cap 46 is typically obtained from a hard rubber or polymer material.

In a similar manner an assist device second trunk adapter cap 48 is affixed with the assist device second trunk adapter 40. The assist device second trunk adapter cap 48 functions in a similar manner to the assist device first trunk adapter cap 46.

As best seen in the FIG. 5 is an assist device bumper 50. The assist device bumper 50 is a hard rubber or polymer material of a generally cylindrical shape. The assist device bumper 50 is centrally located on the upper surface of the assist device base 12.

The assist device bumper 50 functions to prevent the assist device base first folding mechanism 14 from contacting the assist device base 12. The purpose for the assist device bumper 50 in interrupting the free rotational movement of the assist device base first folding mechanism 14 and the assist device base second folding mechanism 18 is to aid in ease of loading and unloading an item with the assist device 10. Stated otherwise, the upper surface of the assist device base first folding mechanism 14 and the assist device base second folding mechanism 18 will intersect the plane of the upper surface of the assist device base 12 when the assist 10 is in a folded condition.

The assist device bumper 50 permits the forward and the reverse motion for the removal of the collapsible wheelchair to be accomplished with ease. Thus, it is desired that the assist device base 12 and the assist device base first folding mechanism 14 not lie in parallel planes but rather maintain a stored collapsible wheelchair in a relationship of the intersecting plane of the assist device base 12 and the assist device base first folding mechanism 14.

An assist device front roller mechanism 54 is connected with the left front lower surface of the assist device base 12. An assist device rear roller mechanism 56 is connected with the left rear lower surface of the assist device base 12.

A second assist device front roller mechanism 54 is connected with the right front lower surface of the assist device base 12. A second assist device rear roller mechanism 56 is connected with the right rear lower surface of the assist device base 12. The left side front roller mechanisms 54 are inline with one another. The right side front roller mechanisms 56 are in line with one another.

The pair of assist device front roller mechanisms 54 and the pair of assist device rear roller mechanisms 56 are trucks with wheels to permit translational movement of the assist device base 12 along the assist device first rail 24 and the assist device second rail 26.

Turning to FIG. 2, an assist device first retainer 76 is located at the corner of the assist device base second folding mechanism 18 nearest the assist device first crossbar 20. An assist device second retainer 78 is located diagonally lengthwise on the assist device base second folding mechanism 18 from the assist device first retainer 76.

In a typical construction of the assist device 10, the assist device base first folding mechanism 14 and the assist device base 12 will not lie in the same plane due to the extension of the length of the assist device base first folding mechanism 14. In its fully extended to position the assist device base first folding mechanism 14 will contact to the assist device first crossbar 20 thereby providing a stop for the extension of the assist device base first folding mechanism 14.

The assist device base 12, the assist device base first folding mechanism 14, and assist device base second folding mechanism 18 may be conveniently clad with a vinyl material to protect that the finish of a vehicle in which to the assist device 10 is installed. Similarly the assist device first retainer 76 and assist device second retainer 78 may be clad with a vinyl material to protect an item of such as a wheelchair which is to be lifted by the assist device 10.

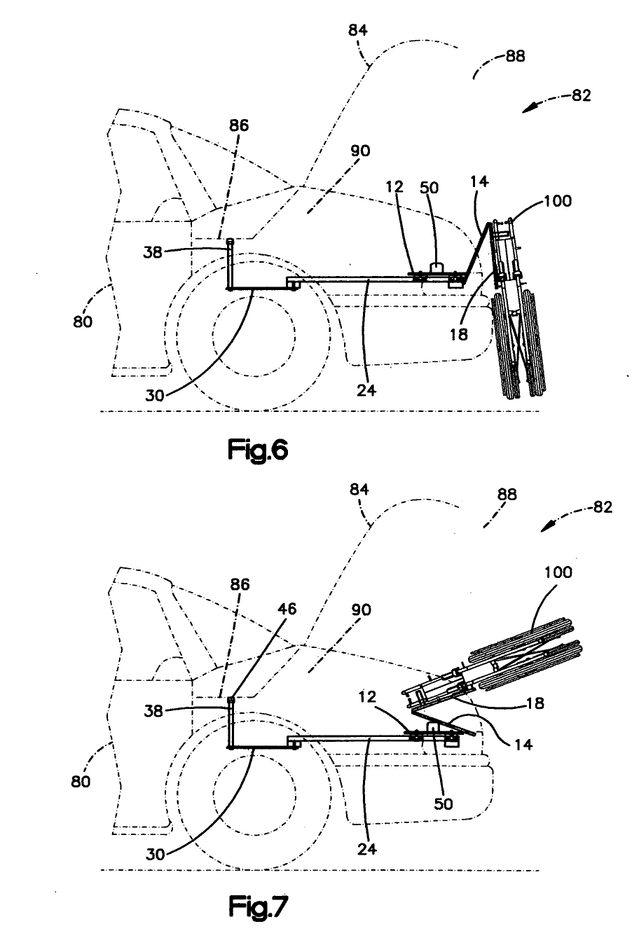

With reference to the drawings the operation of the assist device 10 is best explained. As best seen in FIG. 6, the assist device 10 is fixed to an automobile 80. The automobile 80 is of conventional passenger vehicle construction having as a cargo storage area an automobile trunk 82 with a moveable trunk lid 84. The automobile 80 has a non-movable automobile trunk roof 86. An automobile trunk opening 88 is at least partially defined by the automobile 80, the moveable trunk lid 84, and the automobile trunk 82. The automobile 80 and the moveable trunk lid 84 in a closed condition define an automobile trunk interior 90.

The assist device 10, in a collapsed condition, is placed in the automobile trunk interior 90 through the automobile trunk opening 88 formed by the open condition of the moveable trunk lid 84. The assist device rotatable first arm 30 and the assist device rotatable second arm 32 are rotated by means of the assist device pivot mechanisms 34 such that the assist device rotatable first arm 30 and the assist device rotatable second arm 32 are within the trunk below the non-movable automobile trunk roof 86. That is, that the assist device first trunk adapter 38 and the assist device second trunk adapter 40 are below the non-movable automobile trunk roof 86. The assist device trunk adapter height adjusters 42 are then vertically adjusted to raise the height of the assist device first trunk adapter 38 and the assist device second trunk adapter 40 to firmly contact the non-movable automobile trunk roof 86.

Pursuant to FIG. 1, an assist device 10 is fully extended from the automobile trunk 82 of the automobile 80. A standard collapsible wheelchair 100 is placed into its folded configuration. The standard collapsible wheelchair 100 is simultaneously lifted by its armrest and handle for positioning on the assist device 10. The armrest of the standard collapsible wheelchair 100 is orientated onto the assist device first retainer 76 while the handle of the standard collapsible wheelchair 100 is orientated to the assist device second retainer 78. The armrest and the handle of the standard collapsible wheelchair 100 are gravitationally held in place by the assist device first retainer 76 and the assist device second retainer 78.

As seen in FIG. 6, the bottom of the wheels of the standard collapsible wheelchair 100 is now a small distance off the ground to rear of the vehicle 80. The handles of the standard collapsible wheelchair 100 are at a slight angle tilted toward the automobile trunk interior 90 of the automobile 80.

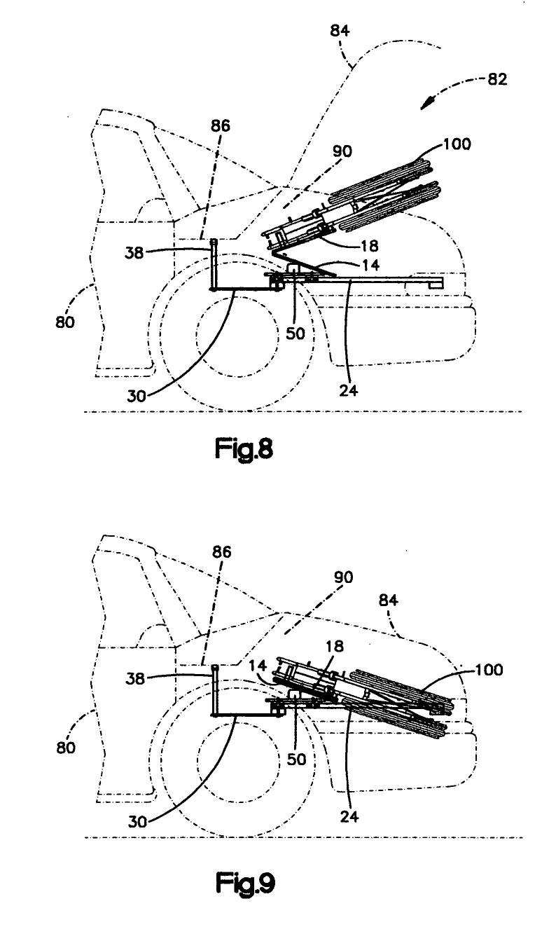

Pursuant to FIG. 7, the standard collapsible wheelchair 100 is lifted by its wheels to a sufficient height to clear the automobile trunk opening 88 for placement into the automobile trunk interior 90. As seen in FIG. 8, the standard collapsible wheelchair 100 has been lifted sufficiently and the assist device 10 is urged along the assist device first rail 24 and the assist device second rail 26 into the automobile trunk interior 90. The bottom portion of assist device base first folding mechanism 14 is now resting on assist device bumper 50.

As shown in FIG. 9, the wheels of the collapsible wheelchair 100 are then lowered into a position where the wheels of the collapsible wheelchair 100 are resting on the floor of the automobile trunk 82. The standard collapsible wheelchair 100 may then be pushed into the automobile trunk 82 and the assist device base first folding mechanism 14 comes to rest against that the assist device bumper 50. At this point the assist device 10 with the standard collapsible wheelchair 100 mounted thereon is slid along the rail assist device first rail 24 and assist device second rail 24 by means of the assist device front roller mechanisms 54 and the assist device rear roller mechanisms 56. To remove the standard collapsible wheelchair 100 the process is reversed. The assist device bumper 50 positions the standard collapsible wheelchair 100 such that removal of the standard collapsible wheelchair 100 is facilitated.

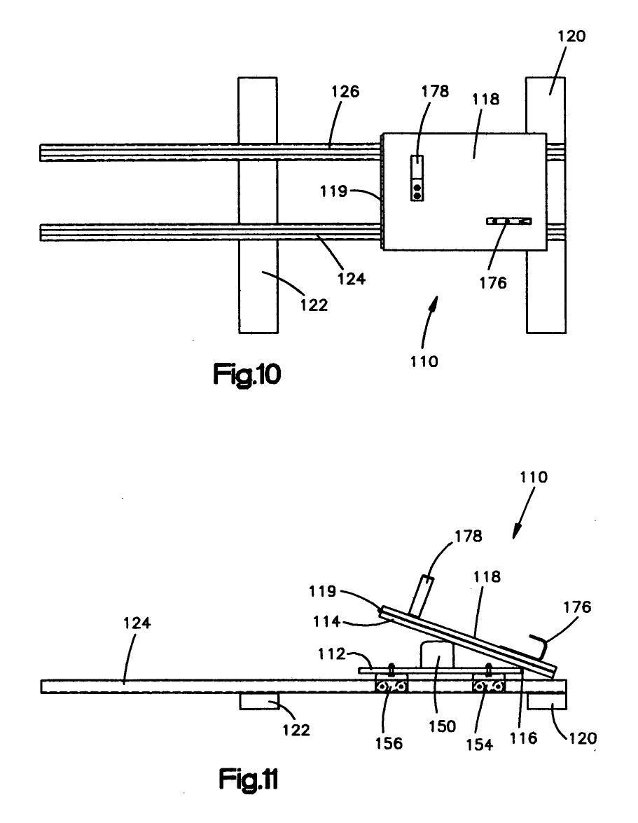

A further embodiment of the invention is shown in FIG. 10 and FIG. 11. An assist device 110 generally corresponds to the assist device 10 in construction and function. That is, the assist device base 112, the assist device base first folding mechanism 114, assist device first hinge 116, assist device second hinge 119, assist device first hinge 118, assist device first crossbar 120, assist device second crossbar 122, assist device first rail 124, assist device second rail mechanism 126, assist device second hinge 128, assist device bumper 150, assist device front roller mechanism 154, assist device rear roller mechanism 156, assist device first retainer 176, and the assist device second retainer 178 function as do their counterparts in the first mode.

The assist device base 112 together with the assist device first rail 124, the assist device second rail 126, the assist device first crossbar 120, and the assist device second crossbar 122 is sufficiently weighted to maintain the assist device 110 in a stable configuration even when the standard collapsible wheelchair 100 is in the most extended position as in FIG. 6.

From the above description of the invention, those skilled in the art will perceive improvements, changes and modifications. Such improvements, changes and modifications within the skill of the art are intended to be covered by the appended claims.

What is claimed is:

1. An assist device for use in a motor vehicle comprising:
an assist device base;
an assist device first folding mechanism assist device base first folding mechanism movably connected with said assist device base;
an assist device base second folding mechanism movably connected with said assist device first folding mechanism; at least one assist device front roller mechanism connected with said assist device base;
an assist device first rail; and,
said at least one assist device front roller mechanism slidable within said assist device first rail.

2. The assist device for use in a motor vehicle according to claim 1, further including at least one assist device rotatable first arm and connected with said at least one assist device rotatable first arm at least one assist device first trunk adapter.

3. The assist device for use in a motor vehicle according to claim 1, further including at least one assist device rotatable first arm and connected with said at least one assist device rotatable first arm at least one assist device first trunk adapter, provided further that said at least one assist device first trunk adapter is adjustable lengthwise in a direction substantially perpendicular to the lengthwise dimension of said at least one assist device rotatable first arm.

4. The assist device for use in a motor vehicle according to claim 1, having at least two inline assist device front roller mechanisms connected with said assist device base.

5. The assist device for use in a motor vehicle according to claim 1, wherein said assist device base has located thereon at least one assist device bumper.

6. The assist device for use in a motor vehicle according to claim 1, wherein said assist device base second folding mechanism is connected with at least one assist device first retainer.

7. The assist device for use in a motor vehicle according to claim 1, wherein said assist device base second folding mechanism is connected with an assist device first retainer and an assist device second retainer.

8. The assist device for use in a motor vehicle according to claim 1, having at least two sets of inline assist device front roller mechanisms each connected with said assist device base provided further that one of said sets of inline assist device front roller mechanisms is received by an assist device first rail and that the other set of inline assist device front roller mechanisms is received by an assist device second rail.

9. The assist device for use in a motor vehicle according to claim 1, wherein an assist device first crossbar is connected with said assist device first rail.

10. The assist device for use in a motor vehicle according to claim 1, wherein an assist device first crossbar is connected with said assist device first rail and an assist device second crossbar is connected with said assist device first rail.

11. The assist device for use in a motor vehicle according to claim 1, wherein an assist device first crossbar is connected with both said assist device first rail and an assist device second rail and provided further an assist device second crossbar is connected with said assist device first rail and said assist device second rail.

12. The assist device for use in a motor vehicle according to claim 1, wherein said assist device has a weight from about 25 pounds to about 55 pounds.

13. The assist device for use in a motor vehicle according to claim 1, installed in a passenger automobile having a trunk.
